(19) United States
(12) Patent Application Publication
(10) Pub. No.: US 2026/0316312 A1
(43) Pub. Date: Oct. 15, 2026

(54) Perforator Unit and Indexer for Perforator Unit

(71) Applicant: BW Converting, Inc., Green Bay, WI (US)

(72) Inventors: Michael E. Techlin, Green Bay, WI (US); Steve Jansen, Green Bay, WI (US)

(21) Appl. No.: 19/108,495

(22) PCT Filed: Jun. 21, 2024
(86) PCT No.: PCT/US2024/034922

§ 371 Date: Mar. 4, 2025

Related U.S. Application Data
(60) Provisional application No. 63/522,906, filed on Jun. 23, 2023.

(51) Int. Cl. B26D 1/38; B26D 5/06; B26D 7/20; B26D 7/26; B26F 1/08

(52) U.S. Cl. CPC B26D 1/385; B26D 5/06; B26D 7/204; B26D 7/265; B26F 1/08

(57) ABSTRACT

A perforator cuts perforations into web materials and includes an indexer for moving a stationary roll of the perforator between a plurality of angular positions. In one aspect, the indexer includes a phasing plate with a plurality of holes, a pivot arm with a hole that is mounted adjacent to the phasing plate to allow relative rotation between the pivot arm and the phasing plate, a pin movable into and out of each hole of the phasing plate and the pivot arm hole, a pin actuator mounted on the pivot arm to move the pin, and a pivot arm actuator to oscillate the pivot arm. In another aspect, the indexer includes a follower connected with the stationary roll, a crank arm, a coupler pivotally connected to the follower and the crank arm, and a crank arm actuator to drive the crank arm and move the coupler and the follower.

### RELATED APPLICATION DATA

This application claims priority benefit to U.S. provisional application Ser. No. 63/522,906, filed Jun. 23, 2023, the disclosure of which is incorporated by reference herein.

### BACKGROUND

Perforators are used to cut perforations into web materials. Perforations typically comprise a pattern of discontinuous cuts, having regions that are severed alternating with regions that are attached. Perforations are used to provide lines of weakness in the web materials so the web can be severed along the lines of weakness by applying tension to the web. The web may be severed along the perforation by the end user, for dispensing, or as part of the converting process. Tissue webs in roll form, such as bath tissue and kitchen towel, and nonwovens webs in roll form, such as canister wipes, typically have perforations for dispensing. The machines used for winding the web into roll form often also snap the web at a perforated line of weakness as part of the cut-off and transfer process to end the winding of a roll and initiate winding of the next roll. Other webs may also be perforated to similar effect, for instance, plastic film.

Most tissue rewinders have perforators. Typically, modern perforators have a rotating roll with helically mounted blades that have continuous edges. The blades on the rotating roll operate against blades that have notched edges and are mounted straight on a non-rotating roll, also called a stationary roll. The tissue web is cut with a perforation pattern as it passes between the rolls. The perforation pattern is based on the pattern of notches in the edge of the blade on the stationary roll because the web is not cut in the locations where there are notches in the blade. The distance between the rolls is set so that the blade on the stationary roll has an interference condition with the blades on the rotating roll such that there is adequate pressure for the cooperating blades to cut the web. A typical adjustment on the perforator is to increase or decrease this interference to an appropriate level, where more interference yields greater cutting pressure and less interference yields less cutting pressure. The pair of rolls is typically skewed relative to the web, so they are canted rather than perpendicular to the direction of travel of the web, to compensate for the helix of the blades on the rotating roll, so that the lines of perforation are perpendicular to the direction of travel of the web.

The rotating roll typically has multiple blades mounted on it, but may have only one blade mounted. The quantity of blades on the rotating roll usually depends on the pitch distance between sequential lines of perforation, also called the perforation length, that is desired. Only one blade on the stationary roll is used when perforating the web, so only one blade may be provided on the stationary roll. However, it is typical to provide multiple blades on the stationary roll, for versatility. It is common for two blades or four blades to be provided. Other quantities of blades may be provided. When any one of the blades is at the operating position for perforation, the others are in reserve away from the operating position, and can be indexed to the operating position for use when necessary or desired. Mounting the blades on a perforator roll requires time and skill and is usually done by a maintenance technician. There is value in switching quickly between notched perforator blades mounted on the stationary roll. For instance, switching between notched perforator blades may be necessary to change the patterns between toilet tissue and kitchen towel, or because a blade is broken or becomes worn. It is highly desirable that an operator be able to make this change, rather than waiting for a maintenance technician. Accordingly, there is a need to index the orientation of the stationary roll from one blade to another blade in a manner that tools are not required, for instance, to make indexing easier for the operator. More preferably, it is desirable the machine can execute indexing of the stationary roll in an automated fashion without the operator having to perform any tasks inside the perimeter guards. It would also be advantageous for the machine to automatically change between blades, for instance if perforation defects are detected or suspected, without intervention by a person.

Having the notched edge blades on the stationary roll and the continuous edge blades on the rotating roll is the typical arrangement in practice. However, mounting the notched edge blades on the rotating roll and the continuous edge blades on the stationary roll is a possible arrangement as well. The indexer embodiments disclosed herein may work with either configuration, providing quicker and simpler change between notched edge blades in the stationary roll pockets in the one case or between continuous edge blades in the stationary roll pockets in the other case.

As described herein, the disclosure presents a stationary roll with pockets, for instance, two or four pockets, for mounting a blade in each pocket, and an indexer that is configured to rotate the stationary roll from one blade pocket to another blade pocket for quickly switching between blades.

### DESCRIPTION OF THE DRAWINGS

FIG. 1 is a perspective view of a portion of a perforator with a conventional helical rotating roll.

FIG. 2 is a partial perspective view of a side of the perforator showing a conventional mechanism for selecting which blade in the stationary roll engages with the blades in the helical rotating roll of the perforator.

FIGS. 3-5 are partial perspective views of a side of the perforator showing an exemplary embodiment of an indexer for the perforator.

FIG. 6 is a partial perspective view of a side of the perforator showing another exemplary embodiment of an indexer for the perforator.

FIGS. 7-14 show the progression of rotation of a stationary roll using the indexer of FIG. 6.

FIG. 15 is a partial top plan view of the perforator showing the indexer of FIG. 6.

### DETAILED DESCRIPTION

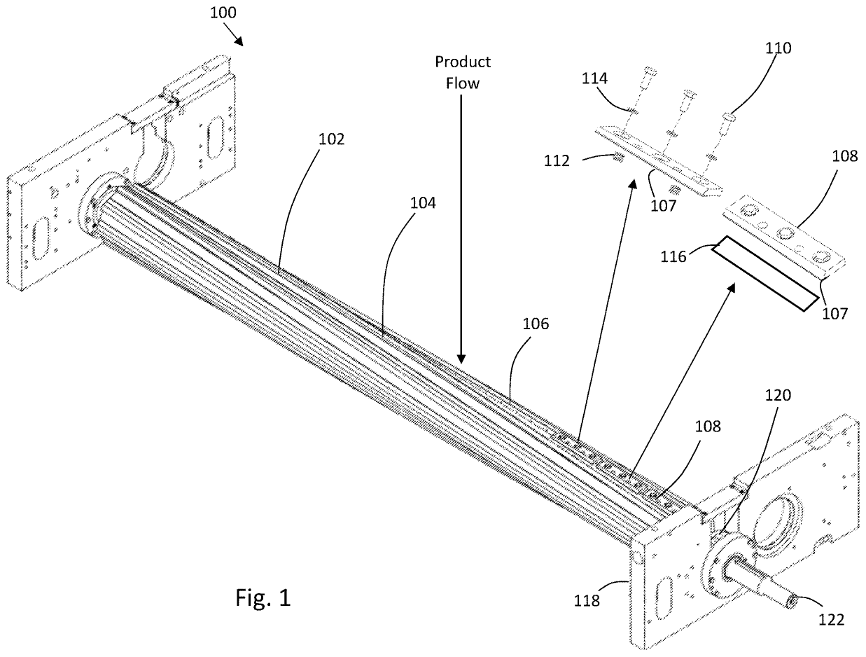

FIG. 1 shows a portion of a perforator 100 with a conventional helical rotating roll 102. The rotating roll 102 has a helical pocket 104 extending along its length into which a blade 106 with a continuous edge is inserted. A blade 106 with a continuous edge is sometimes referred to as an anvil. The blade 106 may be secured in place in the pocket 104 with a clamp 108 and screws 110 that are threaded into the pocket of the rotating roll 102. Compression springs 112 and lock washers 114 may be used with the clamp screws 110. A compliant strip 107 may be provided between the clamp 108 and the blade 106 to promote secure clamping of the blade. A noise abatement foam strip 116 may be located between the underside of the blade 106 and a surface of the pocket 104, in the region of the overhang of the blade. The foam strip 116 may prevent dust and/or debris from collecting under the blade 106 in the region of its overhang while not adversely affecting the flexing of the blade. When the clamp screws 110 are loosened, the compression springs 112 between the clamp 108 and pocket 104 tend to lift the clamp 108 away from the roll 102. In this way, when the clamp screws 110 are partially rotated out, the clamp 108 is lifted by the compression springs 112 to be spaced away from the roll 102. Having the clamps 108 spaced away from the roll 102 is advantageous for cleaning the pocket 104 of any dust or debris and for installing the blade 106, which must be twisted to conform to the helix of the pocket 104. The rotating roll 102 may be rotatably mounted to a frame 118 of the perforator via bearings 120 and rotatably driven via a spindle 122 extending through the frame of the perforator.

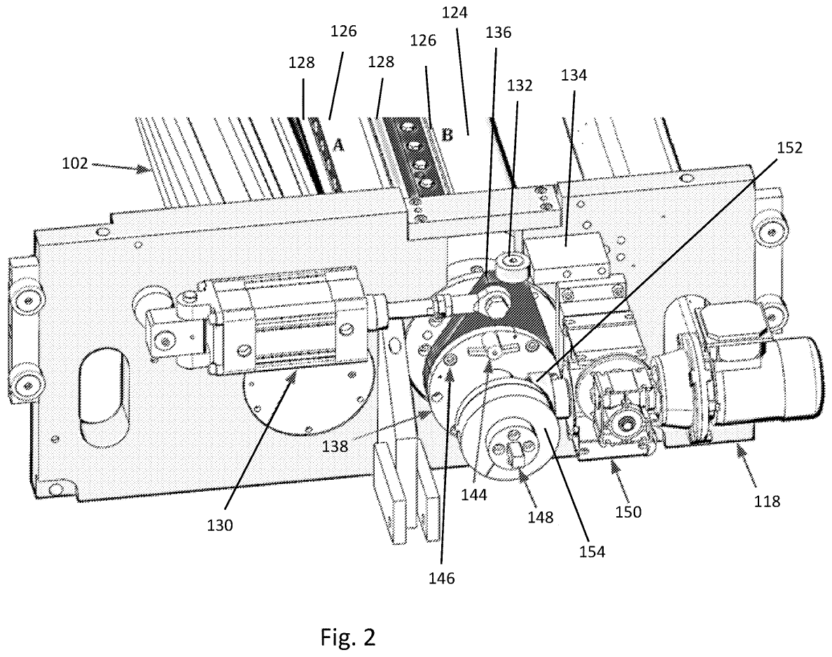

A conventional arrangement of the perforator, including the helical rotating roll 102 described above and a stationary roll 124, is shown in FIG. 2. The stationary roll 124 is provided with pockets 126, for instance, two or four pockets, for mounting a notched blade 128 in each pocket. The pockets 126 may be equiangularly spaced about the stationary roll, for instance, at 90°. As shown in FIG. 2, the stationary roll 124 has a blade 128 at pocket A in the operating position. The stationary roll 124 has a blade 128 at pocket B in a reserve position. The stationary roll 124 is in a perforator engagement configuration, where the blade 128 in pocket A cooperates with the blade 106 on the helical rotating roll 102 to cut perforations in the web material passing between the rolls 102,124.

In the conventional arrangement, the blade 128 in pocket A is brought to the perforator engagement position when a pivot arm actuator 130 extends to rotate the stationary roll 124 (clockwise relative to FIG. 2) until a stop roller 132 is urged against a stop block 134. The stop roller 132 is mounted to a pivot arm 136 that is operatively connected to the stationary roll 124. The stop block 134 is mounted on the perforator frame 118. Urging of the stop roller 132 against the stop block 134 ensures a consistent orientation of the stationary roll 124 relative to the helical rotating roll 102 during normal operation. The pivot arm 136 is mounted on a phasing hub 138. The phasing hub 138 is mounted on the stationary roll journal with a clamp and key (not shown), so it is fixed on the stationary roll. The pivot arm 136 and phasing hub 138 have a fixed relative orientation when a pin 144 and mounting screws 146 are installed. The relative orientations of the pivot arm 136 and the phasing hub 138 can be changed when the pin 144 and screws 146 are removed. The pivot arm 136 has a single hole for the pin 144. The phasing hub 138 has four holes for the pin 144, each aligned in phase with a blade pocket 126 on the stationary roll 124.

To begin perforating operation, the pivot arm actuator 130 extends to place a blade 128 on the stationary roll 124 into engagement with the blades 106 on the helical rotating roll 102. As the pivot arm actuator 130 extends, it rotates the stationary roll 124 until the stop roller 132 contacts the stop block 134. This brings the blade 128 in pocket A from below a point of contact with the blades 106 in the rotating roll 102 to a point of contact with the blades 106 in the rotating roll 102. To cease the perforating operation, the pivot arm actuator 130 retracts to rotate the stationary roll 124 in the opposite direction, which moves the blade 128 away from the blades 106 in the rotating roll 102 to a disengagement position. The retraction motion of the pivot arm actuator 130 rotates the stationary roll 124 approximately 23° (counter-clockwise relative to FIG. 2) to bring the blade 128 in pocket A to below a point of contact with the blades in the rotating roll 102. The other blades 128 on the stationary roll 124, for instance the blade 128 in pocket B, remain well away from the blades on the rotating roll 102 because they are spaced apart by more than 23°, usually 90°. In some conventional applications the pivot arm actuator 130 is a pneumatic cylinder. Use of a pneumatic cylinder is economical and the necessary engagement precision of the stationary roll is provided by the stop roller 132 acting against the stop block 134. In other conventional applications the pivot arm actuator may be an electric servo motor driving a linear actuator.

The stationary roll 124 may be indexed to use different blades 128 in other pockets 126 by removing the screws 146 with a wrench and removing pin 144. When the screws 146 and pin 144 are removed, the stationary roll 124 can be rotated relative to the pivot arm 136. The stationary roll 124 can then be freely rotated because the phasing hub 138 has been de-coupled from the pivot arm 136. The stationary roll 124 may be rotated manually using a wrench on a turnover nut 148. After the stationary roll 124 has been reoriented as desired, for instance switching from pocket A to pocket B by bringing the orientation of pocket B into the former orientation of pocket A, the pin 144 is re-inserted and the screws 146 are replaced.

The stationary roll 124 may be reciprocated laterally along its center axis to provide for a more even wear of the notched blades 128 on the stationary roll 124 against the continuous blades 106 on the rotating roll 102. A motor and gearbox 150 may be used to provide reciprocating motion to the roll through an eccentrically mounted roller 152 disposed between the phasing hub 138 and a clamp collar 154.

The arrangement shown in FIG. 2 may be replaced with an auto-indexer as described below.

### Auto Indexer Embodiment 1

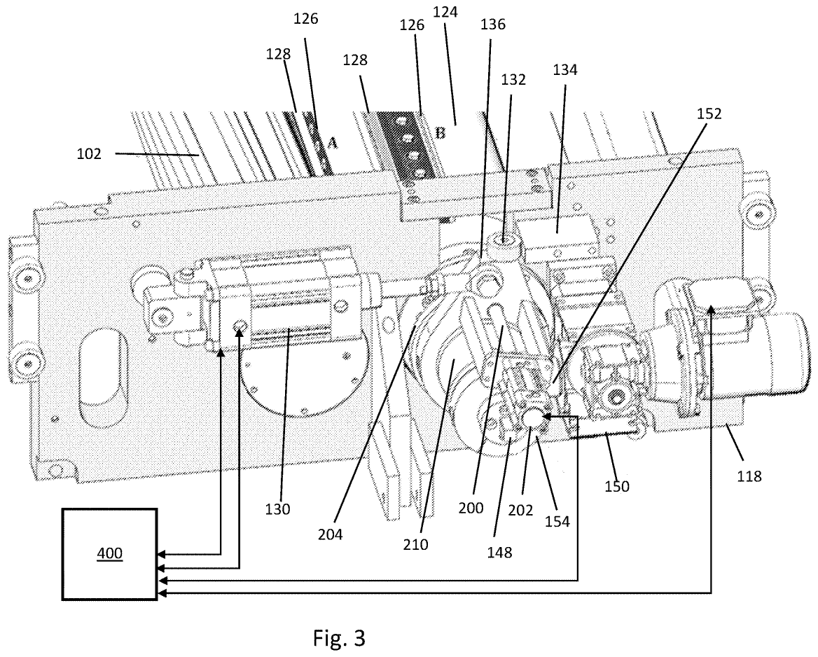

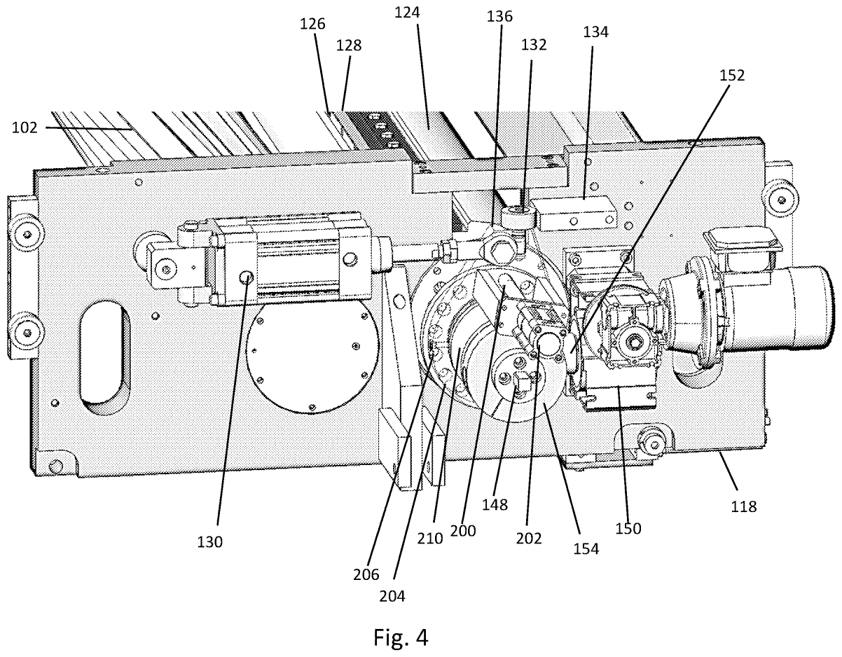

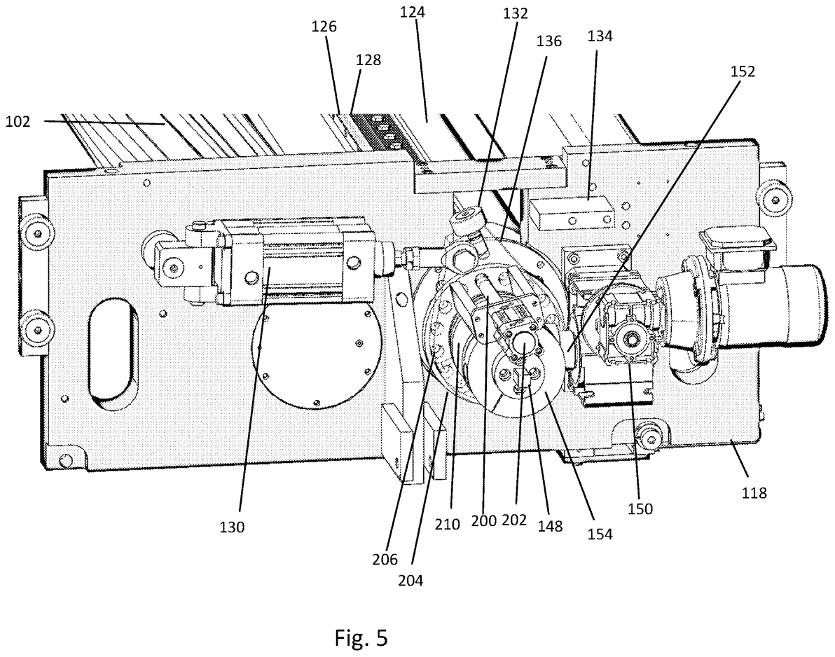

FIGS. 3-5 show an exemplary embodiment of an auto indexer for the perforator 100. The embodiment shown in FIGS. 3-5 shares many of the same components as the conventional system of FIG. 2, and accordingly, like components are indicated with the same reference characters. In FIGS. 3-5, the hand-operated pin 144 from the manual system is replaced with an elongated pin 200 that is actuated axially by a pin actuator 202. The screws 146 that were removed for indexing the roll as shown in the manual system of FIG. 2 are omitted. The elongated pin 200 may have a tapered nose configured to seat precisely in tapered holes located in the phasing plate 204. The pivot arm 136 has a single hole for the elongated pin 200. The phasing plate 204 has a plurality of holes that are adapted to receive the elongated pin 200. As shown in FIG. 4-5 where the pivot arm 136 is transparent for clarity, the phasing plate 204 has an integer number multiple of holes for each pocket in the stationary roll 124. For instance, for four pockets 126 in the stationary roll 124, the phasing plate 204 may have sixteen equally spaced holes 206. Thus, the holes 206 in the phasing plate 204 may be provided at 22.5° increments. The pivot arm 136 is mounted on a phasing hub 204,210. The phasing hub may consist of two parts 204,210. The clamp hub portion 210 is mounted on the stationary roll journal with a clamp and key (not shown), so it is fixed on the roll. The phasing plate portion 204 is mounted securely to the clamp hub portion 210 with screws, so it is effectively also fixed to the stationary roll 124. The pivot arm 136 and phasing hub 204,210 have a fixed relative orientation when the pin 200 is extended into a hole 206 of the phasing plate 204. The relative orientations of pivot arm 136 and phasing hub 204,210 can be altered when the pin 200 is withdrawn from the holes 206 in phasing plate 204. The pin actuator 202 may have a rod locking device to ensure the pin 200 stays within a hole 206 of the phasing plate 204.

The pivot arm actuator 130 may extend to orient the stationary roll 124 in the perforator engagement configuration and may retract to orient the stationary roll 124 in the perforator disengagement configuration in the manner described above with respect to FIG. 2. The pivot arm actuator 130 may be a pneumatic cylinder. The pivot arm actuator 130 may comprise a linear actuator controlled by an electric servo motor instead of a pneumatic cylinder, as mentioned above. The pin actuator 202 may be a pneumatic cylinder.

FIGS. 4-5 show a sequence which may be used to index the stationary roll 124 from one blade pocket to a different blade pocket. In FIGS. 4-5, the bushing in the pivot arm 136 has been hidden and the pivot arm 136 is shown transparent for ease of illustration of the principles of operation. At the start of the sequence, the pin actuator 202 withdraws the tip of the elongated pin 200 from the hole 206 in the phasing plate 204. Then, the pivot arm actuator 130 retracts and rotates the pivot arm 136 counter-clockwise approximately 23°. The elongated pin 200 and its cylinder 202 rotate with the pivot arm 136 because they are mounted with brackets to the pivot arm. The interface between the pivot arm 136 and phasing hub 204,210 may be lubricated to minimize friction. Because the stationary roll 124 is heavy, with greater resistance to rotation, it may tend not to rotate. To ensure the stationary roll does not rotate, a brake (not shown) or other suitable device, may be added to prevent the stationary roll 124 from rotating when the pivot arm 136 is rotated. The sixteen holes 206 in the phasing plate 204 are separated by 22.5° from each other so the approximately 23° rotation of the pivot arm 136 brings the tip of the pin 200 into near coaxial alignment with the next hole 206 in the phasing plate 204, but slightly beyond coaxial alignment with that hole.

Then, the pin actuator 202 may extend to move the tip of the elongated pin 200 toward the phasing plate 204. Given the near alignment of the pin 202 to a hole 206 in the plate 204, the tapers on each may cooperate to rotate the pivot arm 136 clockwise slightly and seat the pin 202 into the hole 206. This may be facilitated by having both ports of the cylinder vented to atmosphere, allowing it to extend freely, if the pivot arm actuator 130 is provided as a pneumatic cylinder. If the ports of pivot arm actuator 130 are not vented to atmosphere, or pivot arm actuator 130 is not provided as a pneumatic cylinder, the pin may insert only partially at first, and then become fully inserted for the remainder of its travel when the pivot arm actuator 130 extends to rotate pivot arm 136 clockwise, as described below. If the elongated pin 200 is not in near alignment with a hole 206 in the phasing plate 204, the tip of the pin 200 may press on the surface of the phasing plate 204, between two of the holes 206, until it comes into alignment with, and drops into, a hole 206 in the phasing plate 204 when the pivot arm actuator 130 extends to rotate the pivot arm 136 clockwise, as described below.

After the pin actuator 202 has extended to move the pin 200 to the phasing plate 204, the pivot arm actuator 130 extends to rotate the pivot arm 136 clockwise until the stop roller 132 is brought into contact with the stop block 134. The engagement of the pin 200 with a hole 206 in the phasing plate 204 causes the stationary roll 124 to rotate clockwise with the pivot arm 136. This accomplishes a partial index of 22.5 ° ( 1/16 of a rotation). To index the stationary roll to an adjacent pocket, which in most cases would be 90 ° (¼ of a rotation), the system would execute the preceding steps three more times. In this way, the pivot arm actuator 130, which conventionally has been used for engaging and disengaging the perforator, may be used also as a ratcheting device to automate indexing of the stationary roll between pockets.

When the stationary roll 124 has been reoriented as desired, the pin 202 is left inserted in the corresponding hole 206 in the phasing plate 204. A locking device may be engaged on the elongated pin 200, or the rod of the pin actuator 202, to ensure the pin 200 remains seated in the hole of the phasing plate 204.

In the steps described above, the pivot arm actuator 130 ratcheted the stationary roll 124 clockwise by having the pin 200 engaged during the extension and disengaged during the retraction of the pivot arm actuator 130. Alternatively, the pivot arm actuator 130 may ratchet the stationary roll 124 counter-clockwise by having the pin 200 engaged during the retraction and disengaged during the extension of the pivot arm actuator 130.

It should also be appreciated that the pivot arm actuator 130 may rotate the stationary roll relative to the rotating roll at one of the plurality of indexable perforator blade positions of the stationary roll to bring the respective perforator blade of the stationary roll into and out of register with the perforating blades of the rotating roll, thereby moving the perforator blade of the stationary roll relative to the perforating blades of the rotating roll between a perforator engagement configuration and a perforator disengagement position. In the perforator engagement configuration, the perforating blades of the rotating roll and a perforator blade of the stationary roll are in register with one another to perforate web material passing between the rotating roll and the stationary roll. In the perforator disengagement configuration, the perforating blades of the rotating roll and the perforator blade of the stationary roll are separated from one another. For instance, with the pin actuator 202 extended with the pin 200 in a desired hole 206 of the phasing plate 204, the pivot arm actuator 130 may extend to rotate the pivot arm 136 clockwise and counter clockwise to move the perforator blade of the stationary roll relative to the perforating blades of the rotating roll between the perforator engagement configuration and the perforator disengagement configuration at each stationary roll perforator blade indexable position.

A control 400, for instance a programmable logic control, may be used to synchronize the actuation of the pivot arm actuator 130, the pin actuator 202, a brake actuator (not shown), a rod lock actuator (not shown), and a pneumatic venting actuator (not shown), as applicable. Making reference to FIG. 3, a control 400, for instance a programmable logic control, may be used to send position commands to the pivot arm actuator 130, pin actuator 202, and vents and brakes associated therewith and with the stationary roll 124, as applicable, so as to enable positioning of the stationary roll 124 relative to the rotating roll in a plurality of angular positions, which may include indexable positions of the stationary roll perforator blades and/or the perforator disengagement configuration and the perforator engagement configuration. In one aspect, the control 400 may be configured to retract the pivot arm actuator 130 to a first position and extend the pivot arm actuator 130 to a second position to move the stationary roll from the perforator disengagement configuration to the perforator engagement configuration at one of the stationary roll perforator blade indexable positions. In another aspect, the control 400 may be configured to extend the pivot arm actuator 130 to a first position and retract the pivot arm actuator 130 to a second position to rotate the stationary roll between a first indexable position of the stationary roll relative to the rotating roll in which perforating blades of the rotating roll and a first perforator blade of the stationary roll are in register with one another to perforate web material passing between the rotating roll and the stationary roll, and a second indexable position of the stationary roll relative to the rotating roll in which perforating blades of the rotating roll and a second perforator blade of the stationary roll are in register with one another to perforate web material passing between the rotating roll and the stationary roll. Accordingly, the control 400 may be configured to rotate the stationary roll 124 to index from a blade pocket 126 on the stationary roll 124 to a different blade pocket 126 on the stationary roll 124. By way of example, the control 400 may be configured to enable rotation of the stationary roll 124 in the clockwise direction by: (i) actuating the pivot arm actuator 130 to an extended position; (ii) actuating the pin actuator 202 to move the pin 200 to a retracted position; (iii) actuating the pivot arm actuator 130 to a retracted position to move the pivot arm 136 relative to the stationary roll 124; (iv) actuating the pin actuator 202 to move the pin 200 toward the inserted position in the one of the holes 206 of the phasing plate 204; and (v) actuating the pivot arm actuator 130 to an extended position to move the pivot arm 136 and the stationary roll 124 from a first position to a second position. The control 400 may be configured to repeat steps (ii)-(v) in rotating the stationary roll 124 to cause a first perforator blade of the stationary roll to be indexed out of position for cooperating with the blades on the rotating roll 102 and a second perforator blade of the stationary roll to be indexed into position for cooperating with the blades on the rotating roll. The control 400 may be configured to enable a pneumatic cylinder of the pivot arm actuator 130 to be vented to atmosphere after the pivot arm actuator 130 moves the pivot arm 136 to its retracted position and before the pin actuator 202 actuates to move the pin 200 toward the inserted position in one of the holes 206 of the phasing plate 204. The control 400 may be configured to activate a brake or other suitable holding device on the stationary roll 124 to prevent rotation of the stationary roll 124 when the pivot arm actuator 130 retracts to rotate the pivot arm 136 relative to the stationary roll 124, when the pin 200 is withdrawn from the phasing plate 204. The control 400 may also be configured to control operation of the roll reciprocator 150.

### Auto Indexer Embodiment 2

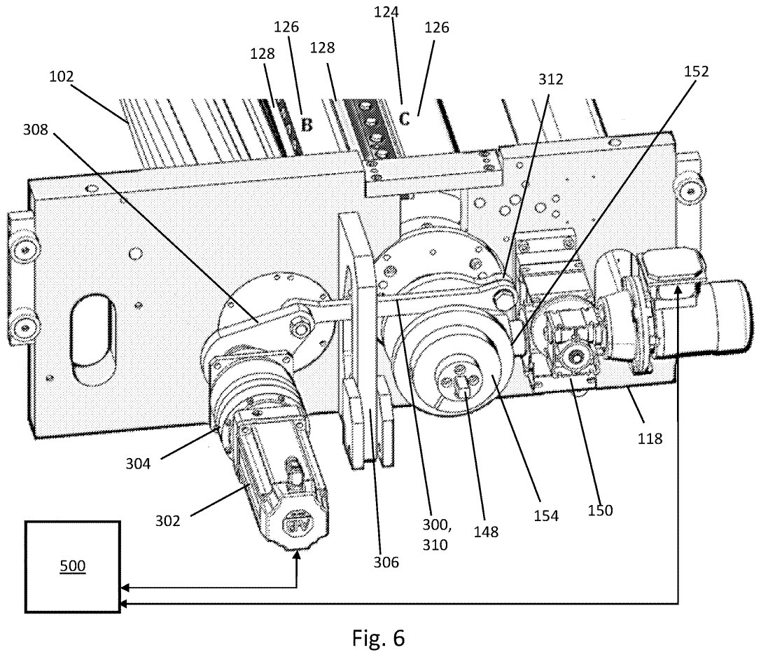

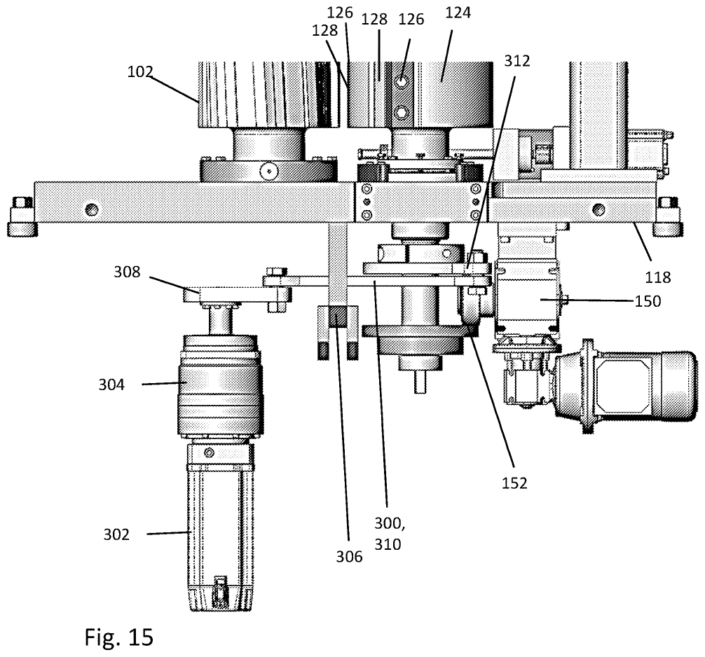

FIGS. 6-15 show another exemplary embodiment of an auto indexer for a perforator 100. The embodiment shown in FIGS. 6-15 shares many of the same components as the conventional system of FIG. 2, and accordingly, like components are indicated with the same reference characters. As described above, the helical rotating roll 102 rotates during operation against the stationary roll 124, which does not rotate during operation. The blade 128 at stationary roll pocket B is in the operating position. The blade 128 at pocket C is in a reserve position. As compared to the embodiment of FIGS. 3-5, in the embodiment of FIGS. 6-15 numerous parts of the stationary roll loading and indexing system are eliminated, including the stop block 134, stop roller 132, pivot arm 136, pivot arm actuator 130, pin 200, pin actuator 202, and the phasing hub 204,210. Instead, the orientation of the stationary roll 124 is set and controlled with a linkage mechanism 300. Preferably a 4-bar linkage may be used. More preferably a parallel 4-bar linkage, which is simple mathematically, may be used. Using a mechanical linkage is advantageous because of its adaptability to the available space, its stiffness and positional repeatability, and its good immunity to dust. It also allows for relatively quick motion when indexing the stationary roll 124 from one pocket to another. Its capability for quick motion may also be useful for fast disengagement of the perforator in the event monitoring of the system, such as by vibration sensors, noise sensors, photo-eye detectors, or a vision system indicates a jam or accumulating debris. In these instances a quick disengagement of the perforator may prevent damage to the cutting blades.

In the exemplary embodiment of FIG. 6 the orientation of the stationary roll 124 is set and controlled by a rotary actuator 302 with a parallel 4-bar linkage mechanism 300. The rotary actuator 302 is preferably an electric servo motor. The servo motor 302 may act through a planetary gearbox 304 which affords a reduction ratio and a more robust mounting for the mechanism crank arm 308. The parallel 4-bar linkage 300 consists of a crank arm 308, coupler 310, and follower 312. The follower 312 is mounted on the stationary roll journal with a clamp and key (not shown), so it is fixed on the roll. The roll reciprocator 150 is the same as before, but may be relocated farther rightward, to make space for the 4-bar linkage 300 when the linkage is at its farthest travel. The roller 152 of the roll reciprocator 150 may operate against the surface of the follower 312. The roller 152 of the reciprocator 150 also operates against the clamp collar 154, which may have increased radius relative to the embodiment of the auto-indexer shown in FIGS. 3-5 to accommodate the reciprocator 150 being relocated farther rightward. The lifting bracket 306 may be modified to accommodate the path of travel of the 4-bar linkage. The turnover nut 148 may be retained so the stationary roll 124 can be manually rotated with a turnover wrench if desired. The servo motor 302 may be provided with a holding brake to keep the stationary roll 124 from moving when the motor is not energized. This may be beneficial, for instance, when a blade 128 is being installed or removed. The motor brake may be deactivated to allow the stationary roll 124 to be manually rotated using a turnover wrench with the turnover nut 148.

The gearbox 304 has a support bracket (not shown) to support it from the perforator frame 118. The gearbox support bracket may have a cutout similar to the cutout in the lifting bracket 306 to allow rotation of the crank arm 308 and passage of the coupler 310. The gearbox support bracket may provide locations for mounting hard stops that provide travel limits for the crank arm. One of these travel limits may function as the servo axis calibration position. Two hard stops may be required to limit the travel of the system, to ensure the follower 312 does not hit the reciprocator roller 152 from above nor from below. A stop may be used to set the servo axis calibration orientation, which is a way to teach a programmable logic control the actual position of the linkage. This stop may be contacted by precision machined surfaces on the crank arm 308. In the alternative, the stop may be provided against precision machined surfaces on the follower 312, if space permits. Because the orientation of the follower 312 is keyed to the stationary roll 124, calibrating the orientation of the follower 312 may be sufficiently precise that further correction with a reference gauge is not necessary. The servo motor 302 controls the orientation of the stationary roll 124 in all positions without using a hard stop, except possibly during calibration.

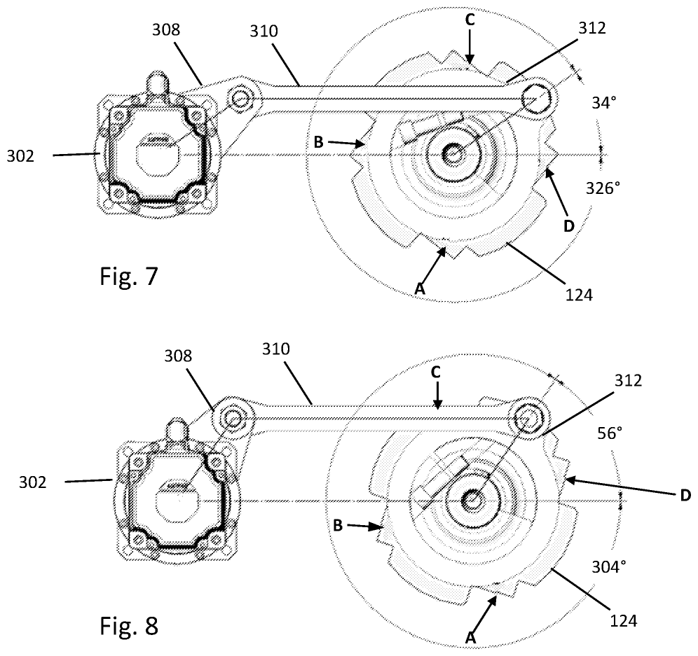

The operating positions of the linkage system 300 are shown in FIGS. 7-14. Making reference to FIG. 7, in the first position, which corresponds to Blade B oriented in the perforator engagement configuration at one indexable position, the crank arm 308 and follower 312 are at an angle of 34° with respect to the horizontal plane. Making reference to FIG. 8, in the second position, the crank arm 308 has been rotated counter-clockwise 22° to orient Blade B for the perforator disengagement configuration at the same indexable position. In this way the servo motor 302 can move a blade on the stationary roll 124, in this example Blade B, between its perforator engagement and disengagement positions.

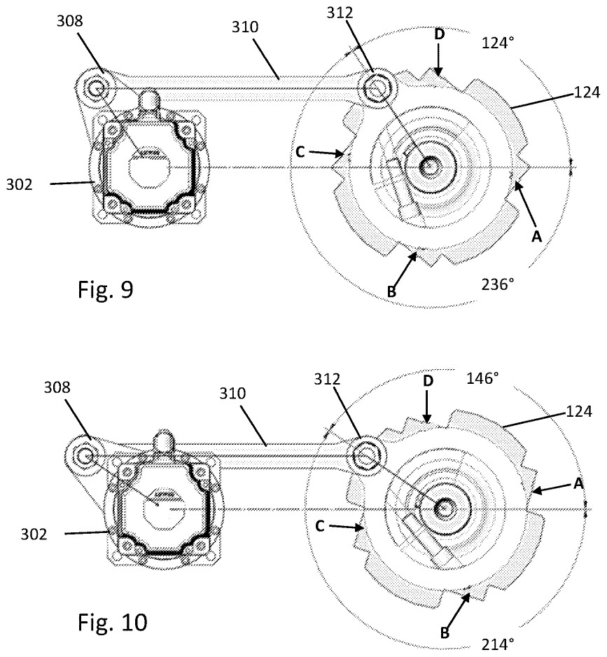

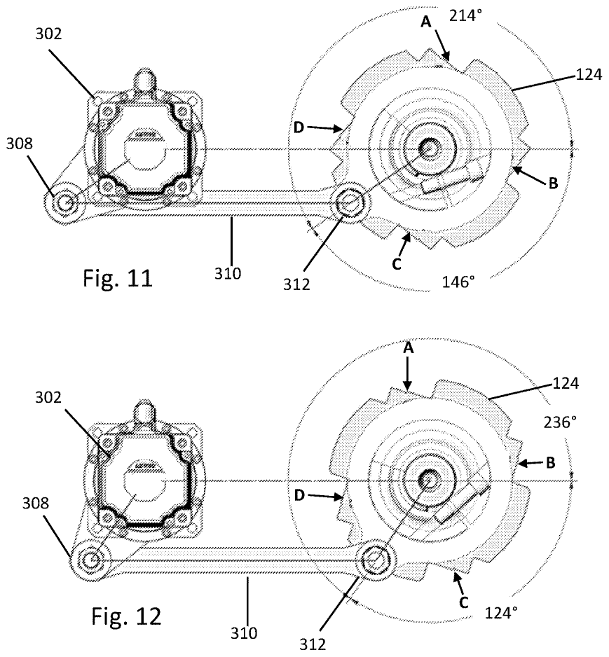

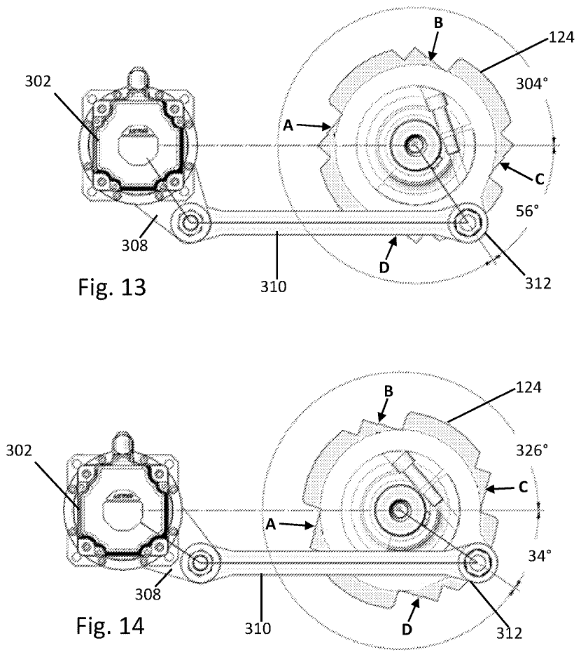

The servo motor 302 is also used to index the stationary roll orientation to bring or index a different perforator blade of the stationary roll into the perforating engagement configuration position, or near the perforating engagement configuration. For instance, servo motor 302 is used to index the linkage system 300 to bring Blade C into the perforator engagement configuration by rotating the crank arm 308 counter-clockwise by 90° relative to FIG. 7 as shown in FIG. 9. Blade C may be brought to its perforator disengagement configuration by additional counter-clockwise rotation of 22° as shown in FIG. 10. The servo motor 302 is used to index the linkage system 300 to bring Blade D into the perforator engagement configuration by rotating the crank arm 308 counter-clockwise by 90° relative to FIG. 9 as shown in FIG. 11. Blade D may be brought to its perforator disengagement configuration by additional counter-clockwise rotation of 22° as shown in FIG. 12. The servo motor 302 is used to index the linkage system 300 to bring Blade A into the perforator engagement configuration by rotating the crank arm 308 counter-clockwise by 90° relative to FIG. 11 as shown in FIG. 13. Blade A may be brought to its perforator disengagement configuration by additional counter-clockwise rotation of 22° as shown in FIG. 14.

In addition to providing perforated products, the indexing device as shown in FIGS. 6-15 may be used to apply a single line of perforation for web severing and transfer in the rewinding process of non-perforated products. For instance, the servo-actuated control of the stationary roll orientation through the linkage may be used to hold the roll in a disengaged configuration during most of the product winding, rapidly move the roll into the engaged configuration and hold it there long enough for a single line of perforation to be applied across the width of the web, and then rapidly move the roll to a disengaged configuration. The stationary roll may be rotated in the opposite direction after the perforation is applied, so the pocket with the blade used to apply the perforation is back near where it started, upstream or downstream of the perforation engagement position. Or it may be rotated in the same direction after the perforation is applied, so the pocket with the blade used to apply the perforation passes to the other side of the perforation engagement position. In this case, the blade on the stationary roll that is used to apply the perforation would alternate pausing upstream and downstream of the perforation engagement position with each application of a perforation. The web which is otherwise non-perforated may then be snapped or torn at this single line of perforations for the cut-off and transfer process to end the winding of a roll and initiate winding of the next roll. Thus, the perforator as shown in FIGS. 6-15 may be used to put lines of perforation in the web with a longitudinal spacing between the lines of perforation that is much greater than the circumference of the helical roll.

While the stationary roll shown in FIGS. 6-15 has uniform pocket spacing of 90°, the pockets may have a different angular spacing. For instance, the pockets may instead be spaced apart by 67° and 113° to allow the mechanical linkage to operate with a transmission angle of 45° instead of 34° which may improve the mechanics and space requirements of the system.

Spherical bushings may be provided at the connection points between the crank arm 308 and coupler 310, and the follower 312 and coupler 310, to accommodate the axial reciprocation of the stationary roll 124 by the stationary roll reciprocator 150.

Making reference to FIG. 6, a control 500, for instance a programmable logic control, may be used to send position commands to the crank arm actuator 302, so as to enable positioning of the stationary roll 124 in the perforator disengagement configuration and the perforator engagement configuration at each indexable position of the respective perforator blade of the stationary roll. The control 500 may also be used to send position commands to cause a first blade 128 on the stationary roll 124 to be rotated out of position for cooperating with the blade 106 on the rotating roll 102 and a second blade 128 on the stationary roll 124 to be indexed into position for cooperating with the blade 106 on the rotating roll 102. In one aspect, the control 500 provides position control signals for the servo motor of the crank arm actuator 302. The control 500 may also be configured to control operation of the roll reciprocator 150.

The above mechanisms, and derivations thereof, may be combined with a system that can detect abnormalities in the perforation attributes or the perforator function. Although there are many methods that could be conceived, there are at least a few that are conceptually sound and founded on the same heuristic methods that an operator or technician may employ.

One such method is visible inspection of the perforation as the web is processed. An exemplary configuration may include a backlighting means and at least one camera configured and arranged to capture the entire width of the perforation across the web. Stroboscopic exposures timed to coincide with the perforation passing in the field of view may be captured while the web span under inspection is under a slight strain. It would be expected to see light passage proportional to the perforation cut pattern. Extending this, more detailed image evaluations can also be done in real time to look for missing elements of the perforation pattern across the web using image analysis tools. Abnormalities can be classified to provide prescriptive feedback to the machine operator to take remedial action. For example, insufficient cut definition detected at one side of the web may prompt feedback to the operator prescribing to increase the interference of the cutting blades at that side of the web. Alternatively, the programmable logic control may increase the interference of the cutting blades and may notify the operator an adjustment was made.

Another implementation involves utilizing acoustic characteristics of the perforation process. Those familiar with perforators as described know that there are distinct audible signatures that are related to various abnormalities in condition or setup that lead to non-conforming results. This includes, but is not limited to, excessive interference of the cutting blades, unbalanced loading across the perforator, and damage to the blades. Such a system employs at least one microphone, preferably at least two, and associated preamplifiers and signal processing means. The microphones are positioned in known locations within the machine in proximity to the perforator and preferably spaced equidistant from each other axially across the perforator. The system captures time stamped audio as the perforator runs. The captured audio signal is transformed to frequency domain data. Given a machine operating state, the frequency bins associated with the perforation timings are identified by peak power characteristics in relation to rotational position of the rotating roll 102. As the rotational position of the rotating helical roll 102 changes within the helix arc, the position of the associated contact area moves across the perforator, from one side of the machine to the other. The time stamping of sample clusters and real time stream allow the signal to be related to the perforation process and contact region position and in relation to which blade is in contact of the multiple blades in the rotating roll. That is, given a known geometry and rotational position of the blades on the rotating perforator roll, a time stamp can be related to contact area of the helical roll blade 106 and stationary roll blade 128 across the face of the rolls. Technologies such as the ODVA CIP Sync Standard allow for association of time to events and positions in a coordinated control system. With this relationship, variation in the frequencies and magnitude of the signal as the contact region moves across the machine can indicate abnormal setup or condition. For example, as the contact region moves across the face of the perforator roll, a steep change in amplitude may indicate a skip or damaged position. This position across the machine would be known and can be used to direct personnel where to inspect. With an automated stationary roll indexer as described herein, when an abnormality is detected the machine could be stopped, a new blade position could be automatically indexed, and the machine could be restarted. This would save time and reduce production of non-conforming product. Many different classification methods could be applied to various transforms of the data described above to prevent producing non-conforming product and reduce the burden on personnel to identify and resolve those issues.

Further embodiments can be envisioned by one of ordinary skill in the art after reading this disclosure. In other embodiments, combinations or sub-combinations of the above-disclosed invention can be advantageously made. The example arrangements of components are shown for purposes of illustration and it should be understood that combinations, additions, re-arrangements, and the like are contemplated in alternative embodiments of the present invention. Thus, various modifications and changes may be made thereunto without departing from the broader spirit and scope of the invention as set forth in the claims and that the invention is intended to cover all modifications and equivalents within the scope of the following claims.

1. An indexing apparatus for a perforator unit wherein the perforator unit has a rotating roll, and a stationary roll with a plurality of indexable positions, the indexing apparatus being configured to move the stationary roll relative to the rotating roll between: (a) a first indexable position of the stationary roll relative to the rotating roll in which at least one perforating blade of the rotating roll and a first perforator blade of the stationary roll are in register with one another to perforate web material passing between the rotating roll and the stationary roll, and (b) a second indexable position of the stationary roll relative to the rotating roll in which the at least one perforating blade of the rotating roll and a second perforator blade of the stationary roll are in register with one another to perforate web material passing between the rotating roll and the stationary roll, the indexing apparatus comprising:
a phasing plate adapted and configured to be fixably connected with the stationary roll in a manner such that the phasing plate rotates with the stationary roll, the phasing plate having a plurality of holes spaced about the phasing plate;
a pivot arm adapted and configured to be operatively mounted adjacent to the phasing plate to allow relative rotation between the pivot arm and the phasing plate, the pivot arm having a hole;
a pin adapted and configured to be received in each hole of the plurality of holes of the phasing plate and in the pivot arm hole;
a pin actuator operatively mounted on the pivot arm, the pin actuator being adapted and configured to move the pin between an inserted position and a retracted position, wherein in the inserted position, the pin actuator moves the pin through the pivot arm hole and into one of the plurality of holes of the phasing plate; and wherein in the retracted position, the pin actuator moves the pin out of the one hole of the plurality of holes of the phasing plate;
a pivot arm actuator operatively connected to the pivot arm, the pivot arm actuator being configured to oscillate the pivot arm between a first pivot arm position and a second pivot arm position; and
a programmable control configured to enable rotation of the stationary roll from the first indexable position to the second indexable position by: (i) actuating the pin actuator to move the pin to the retracted position; (ii) actuating the pivot arm actuator to move the pivot arm to the second pivot arm position; (iii) actuating the pin actuator to move the pin to the inserted position; and (iv) actuating the pivot arm actuator to move the pivot arm to the first pivot arm position.

2. The indexing apparatus of claim 1 wherein the programmable control is configured to execute the steps (i)-(iv) at least twice in rotating the stationary roll between the first indexable position and the second indexable position.

3. The indexing apparatus of claim 1 wherein the pivot arm actuator comprises a linear actuator.

4. The indexing apparatus of claim 3 wherein the pivot arm actuator comprises a pneumatic cylinder.

5. The indexing apparatus of claim 4 wherein the programmable control is configured to enable the pneumatic cylinder to be vented after the pivot arm actuator moves the pivot arm to the second pivot arm position and before the pin actuator moves the pin to the inserted position.

6. The indexing apparatus of claim 3 wherein the programmable control is configured to extend the pivot arm actuator in the second pivot arm position and retract the pivot arm actuator in the first pivot arm position.

7. The indexing apparatus of claim 3 wherein the programmable control is configured to retract the pivot arm actuator in the second pivot arm position and extend the pivot arm actuator in the first pivot arm position.

8. (canceled)

9. (canceled)

10. (canceled)

11. (canceled)

12. (canceled)

13. (canceled)

14. (canceled)

15. (canceled)

16. (canceled)

17. An indexing apparatus for a perforator unit wherein the perforator unit has a rotating roll and a stationary roll, the indexing apparatus being configured to move the stationary roll relative to the rotating roll between a plurality of angular positions, the indexing apparatus comprising:
a follower adapted and configured to be fixably connected with the stationary roll in a manner such that the follower rotates with the stationary roll;
a crank arm;
a coupler pivotally connected to the follower and the crank arm;
a crank arm actuator adapted and configured to drive the crank arm and move the coupler and the follower; and
a programmable control configured to enable rotation of the stationary roll relative to the rotating roll between a first angular position and a second angular position by actuating the crank arm actuator.

18. The indexing apparatus of claim 17 wherein a first angular position in the plurality of angular positions comprises a perforator engagement configuration in which at least one perforating blade of the rotating roll and a perforator blade of the stationary roll are in register with one another to perforate web material passing between the rotating roll and the stationary roll, and a second angular position in the plurality of angular positions comprises a perforator disengagement configuration in which the at least one perforating blade of the rotating roll and the perforator blade of the stationary roll are separated from one another.

19. The indexing apparatus of claim 17 wherein a first angular position in the plurality of angular positions comprises a first indexable position of the stationary roll relative to the rotating roll in which at least one perforating blade of the rotating roll and a first perforator blade of the stationary roll are in register with one another to perforate web material passing between the rotating roll and the stationary roll, and a second angular position in the plurality of angular positions comprises a second indexable position of the stationary roll relative to the rotating roll in which the at least one perforating blade of the rotating roll and a second perforator blade of the stationary roll are in register with one another to perforate web material passing between the rotating roll and the stationary roll.

20. The indexing apparatus of claim 17 wherein the crank arm actuator comprises a servo motor.

21. The indexing apparatus of claim 20 further comprising a gearbox extending between the servo motor and the crank arm.

22. The indexing apparatus of claim 20 wherein the programmable control provides position control signals for the servo motor.

23. The indexing apparatus of claim 19 wherein the first indexable position is one of at least two indexable positions of the stationary roll relative to the rotating roll and the second indexable position is one of at least two indexable positions of the stationary roll relative to the rotating roll.

24. (canceled)

25. (canceled)

26. (canceled)

27. (canceled)

28. (canceled)

29. (canceled)

30. (canceled)

31. (canceled)

32. (canceled)

33. An indexing apparatus for a perforator unit wherein the perforator unit has a rotating roll and a stationary roll, the indexing apparatus being configured to rotate the stationary roll relative to the rotating roll between a plurality of angular positions, the indexing apparatus comprising a linkage operatively coupled to the stationary roll and an actuator adapted and configured to drive the linkage and rotate the stationary roll relative to the rotating roll between the plurality of angular positions.

34. The indexing apparatus of claim 33 wherein the actuator comprises a servo motor.

35. The indexing apparatus of claim 33 further comprising a gearbox extending between the linkage and the actuator.

36. The indexing apparatus of claim 33 wherein the linkage comprises a four bar linkage.

37. The indexing apparatus of claim 33 wherein a first angular position in the plurality of angular positions comprises a perforator engagement configuration in which at least one perforating blade of the rotating roll and a perforator blade of the stationary roll are in register with one another to perforate web material passing between the rotating roll and the stationary roll, and a second angular position in the plurality of angular positions comprises a perforator disengagement configuration in which the at least one perforating blade of the rotating roll and the perforator blade of the stationary roll are separated from one another.

38. The indexing apparatus of claim 33 wherein a first angular position in the plurality of angular positions comprises a first indexable position of the stationary roll relative to the rotating roll in which at least one perforating blade of the rotating roll and a first perforator blade of the stationary roll are in register with one another to perforate web material passing between the rotating roll and the stationary roll, and a second angular position in the plurality of angular positions comprises a second indexable position of the stationary roll relative to the rotating roll in which the at least one perforating blade of the rotating roll and a second perforator blade of the stationary roll are in register with one another to perforate web material passing between the rotating roll and the stationary roll.

39. (canceled)

40. (canceled)

41. (canceled)

42. (canceled)

43. (canceled)

44. (canceled)

45. (canceled)

46. (canceled)

47. (canceled)
